(19) United States
(12) Patent Application Publication
(10) Pub. No.: US 2025/0267735 A1
(43) Pub. Date: Aug. 21, 2025

(54) METHOD AND APPARATUS FOR REPORTING AND CORRECTING A SELECTED PATH IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Jicheol LEE, Gyeonggi-do (KR)

(21) Appl. No.: 19/050,589

(22) Filed: Feb. 11, 2025

(30) Foreign Application Priority Data
Feb. 15, 2024 (KR) 10-2024-0021969

(51) Int. Cl. H04W 76/12

(52) U.S. Cl. CPC H04W 76/12

(57) ABSTRACT

The disclosure relates to a 5G or 6G communication system for supporting a higher data transmission rate. A method of a terminal in a wireless communication system includes determining whether the UE changes an association of an application to a packet data unit (PDU) Session based on an UE routing selection policy (URSP) re-evaluation, reporting information about a URSP rule matched to the application to a Session Management Function (SMF) using a PDU session modification request message based on the UE associating the application to an existing PDU Session based on the URSP re-evaluation, and reporting information about a URSP rule matched to the application to the SMF using a PDU session establishment request message based on the UE associating the application to a new PDU Session based on the URSP re-evaluation.

### CROSS-REFERENCE TO RELATED APPLICATION(S)

This application is based on and claims priority under 35 U.S.C. § 119 to Korean Patent Application No. 10-2024-0021969, filed in the Korean Intellectual Property Office on Feb. 15, 2024, the disclosure of which is incorporated herein by reference in its entirety.

### BACKGROUND

### 1. Field

The disclosure relates generally to a wireless communication system, and more particularly, to a method and device for reporting and correcting a selected path in a wireless communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial stage of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR user equipment (UE) Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR, VR, and the like (XR=AR+VR+MR), 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A UE may support a UE routing selection policy (URSP) rule enforcement reporting function. The URSP may extend network slicing by dynamically selecting the most suitable network slice for each UE, based on quality of service (QoS), preference, and security requirements. The UE may be provisioned with URSP information that provides information on which a packet data unit (PDU) session of the network slice is to be used when a specific service or application is activated.

A policy control function (PCF) may request URSP rule enforcement reporting and, based on this, identify a PDU session to which an application is associated, and may update the URSP rule as needed.

The UE may perform reporting only when new application traffic is associated to a PDU session. That is, the UE may perform reporting only when information about a PDU session is requested from an application.

However, even when the PDU session of the existing application traffic (i.e., the association) is changed due to mobility problems of the UE, if the reporting target is the URSP rule, the URSP rule is required to be reported, and the UE needs to operate to support this change.

Accordingly, there is a need in the art for a method and an apparatus by which a UE is able to report information about an application, such as an application category or an application identifier, having a selected path that was selected or changed in a wireless communication system.

### SUMMARY

The disclosure has been made to address at least the above-mentioned problems and/or disadvantages and to provide at least the advantages described below.

Accordingly, an aspect of the disclosure is to provide a method for reporting information about an application (e.g., an application category, an application identifier, etc.) having a path (e.g., single-network slice selection assistance information (S-NSSAI and/or data network name (DNN)) that was selected or changed in a wireless communication system.

An aspect of the disclosure is to provide a method for determining whether to make a correction, based on the reported information about the application.

In accordance with an aspect of the disclosure, a method of a UE in a wireless communication system includes determining whether the UE changes an association of an application to a packet data unit (PDU) session based on a UE routing selection policy (URSP) re-evaluation; reporting information about a URSP rule matched to the application to a session management function (SMF) using a PDU session modification request message based on the UE associating the application to an existing PDU session based on the URSP re-evaluation; and reporting information about the URSP rule matched to the application to the SMF using a PDU session establishment request message based on the UE associating the application to a new PDU session based on the URSP re-evaluation.

In accordance with an aspect of the disclosure, a UE in a wireless communication system includes a transceiver and a controller. The controller may be configured to determine whether the UE changes an association of an application to a packet data unit (PDU) session based on a UE routing selection policy (URSP) re-evaluation; report information about a URSP rule matched to the application to a session management function (SMF) using a PDU session modification request message based on the UE associating the application to an existing PDU session based on the URSP re-evaluation; and report information about the URSP rule matched to the application to the SMF using a PDU session establishment request message based on the UE associating the application to a new PDU session based on the URSP re-evaluation.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates a 5G system according to an embodiment;

FIG. 2 illustrates a method for reporting a change in association between an application and a PDU session according to an embodiment;

FIG. 3 illustrates an operation in which a UE reports a matching URSP rule when performing URSP rule re-evaluation according to an embodiment;

FIG. 4 illustrates a UE according to an embodiment; and

FIG. 5 illustrates a network entity according to an embodiment.

### DETAILED DESCRIPTION

Hereinafter, embodiments of the disclosure will be described in detail in conjunction with the accompanying drawings. Detailed descriptions of known functions or configurations that may make the subject matter of the disclosure unclear will be omitted for the sake of clarity and conciseness.

The terms which will be described below are terms defined in consideration of the functions in the disclosure. They may be different according to users, intentions of the users, or customs, and therefore, the definitions of the terms should be made based on the contents throughout the specification.

In the disclosure, terms referring to network entities, network functions, messages, identification information, and the like are illustratively used for the sake of descriptive convenience. Therefore, the disclosure is not limited by the terms as described below, and other terms referring to subjects having equivalent technical meanings may also be used.

Terms and names defined in the 5G system standards will be used for the sake of convenience, but the disclosure is not limited by these terms and names and may be applied in the same manner to systems that conform to other standards.

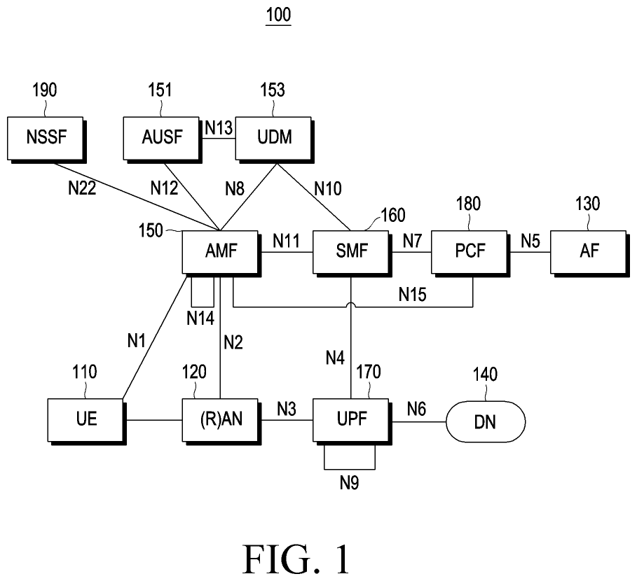

FIG. 1 illustrates a 5G system according to an embodiment.

Referring to FIG. 1, a 5G system or mobile communication network may be configured to include a UE (user equipment or terminal) 110, a radio access network (RAN), base station, gNB (5g nodeB), eNB (evolved nodeB), etc.) 120, and a 5G core network 130 to 190.

The 5G core network 130 to 190 may include at least one of an application function (AF) 130, a data network (DN) 140, an access and mobility management function (AMF) 150 providing a mobility management function of the UE 110, a session management function (SMF) 160 providing a session management function, an authentication server function (AUSF) 151, a unified data management (UDM) 153 providing data management functions such as subscriber data and policy control data, a user plane function (UPF) 170 playing a data transfer role, a PCF 180 providing a policy control function, and a network slice selection function (NSSF) 190. The 5G core network 130 to 190 may be configured to further include network functions such as a unified data repository (UDR) that stores data of various network functions such as UDM.

In a 3^{rd} generation partnership project (3GPP) system, a conceptual link connecting NFs in a 5G system is defined as a reference point. The following shows examples of reference points included in the 5G system architecture shown in FIG. 1.
N1 is a reference point between the UE and AMF.
N2 is a reference point between the (R)AN and AMF.
N3 is a reference point between the (R)AN and UPF.
N4 is a reference point between the SMF and UPF.
N5 is a reference point between the PCF and AF.
N6 is a reference point between the UPF and DN.
N7 is a reference point between the SMF and PCF.
N8 is a reference point between the UDM and AMF.
N9 is a reference point between two core UPFs.
N10 is a reference point between the UDM and SMF.
N11 is a reference point between the AMF and SMF.
N12 is a reference point between the AMF and AUSF.
N13 is a reference point between the UDM and the AUSF.
N14 is a reference point between two AMFs.
N15 is a reference point between the PCF and AMF in non-roaming scenarios, and reference point between the PCF and AMF in visited network in roaming scenarios.

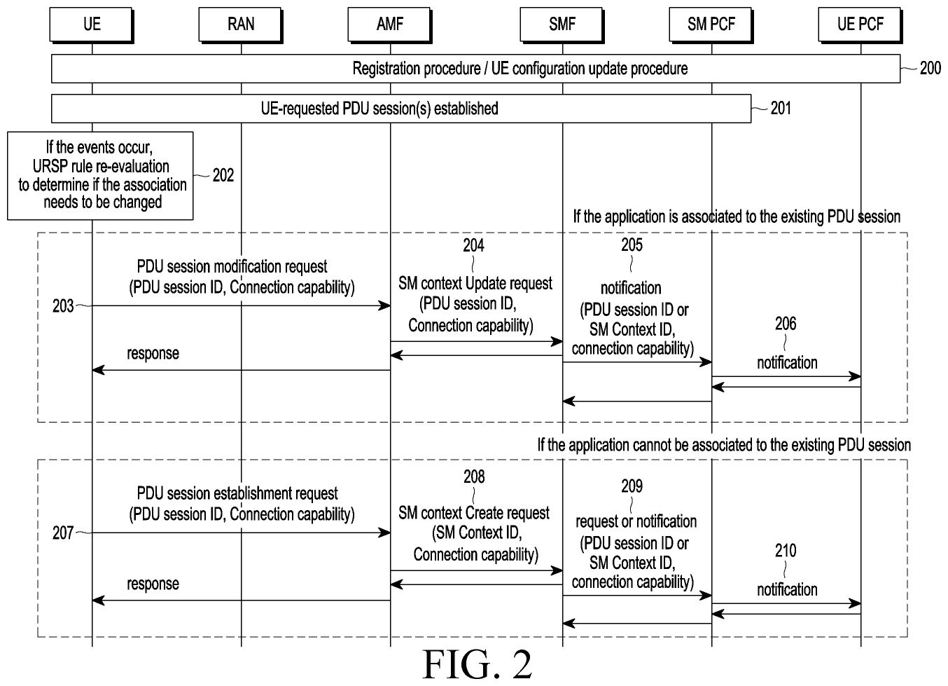

FIG. 2 illustrates a method for reporting a change in association between an application or a personal IoT network (PIN) and a PDU session according to an embodiment. Referring to FIG. 2, a PIN may be used instead of an application, such that the method in FIG. 2 may also be applied to a PIN, as well as an application.

In step 200, the UE may receive a UE policy container including URSP rules from a UE PCF in a registration procedure or a UE configuration update procedure. If a UE policy association request message from the AMF includes an indication of UE capability of reporting URSP rule enforcement to the network along with a UE identifier (ID), the UE PCF, when determining URSP rule(s) for the corresponding UE, may include an indication for reporting the URSP rule enforcement in one or more URSP rules. The UE PCF may further include an indication for further reporting the URSP rule enforcement in the UE policy association request message from the AMF. These two indications may also be included as a single indication in the UE policy association request message and then transmitted.

If a request for PDU session information for application traffic transmission occurs in an upper layer (i.e., when new application traffic is detected) or if a PDU session associated with existing application traffic is changed, the UE may identify whether there is a PDU session established for a URSP rule matching the application information. If so, the UE may configure the corresponding session as a PDU session associated with the application and transmit application traffic to the PDU session. If there is no PDU session established for the URSP rule matching the application information, the UE may transmit a new PDU session establishment request, based on the matching URSP rule, to establish a new PDU session, and may then configure the PDU session as a PDU session associated with the application and transmit application traffic to the PDU session.

Specifically, a URSP rule may include a precedence, an indication for reporting URSP rule enforcement, an indication for further reporting URSP rule enforcement, a traffic descriptor, and a route selection descriptor.

The precedence indicates the relative priority of the URSP rule, and the UE may identify whether a URSP rule with a lower precedence is preferentially matched. The evaluation may be performed preferentially for the corresponding URSP rule.

The indication for reporting URSP rule enforcement may be included in each URSP rule. When a new or existing PDU session is associated based on a URSP rule matched to a newly detected application, if the URSP rule includes an indication for reporting URSP rule enforcement, the UE may transmit a PDU session establishment request message or a PDU session modification request message, and may include the connection capability of the URSP rule matched to the application in the message.

The indication for further reporting URSP rule enforcement may be included in each URSP rule. When an existing or ongoing application is associated with a new or established PDU session other than an existing PDU session associated therewith (i.e., when association between the application and the PDU session is changed), based on the URSP rule matched to the existing application, if the URSP rule includes an indication for further reporting URSP rule enforcement (or an indication for reporting URSP rule enforcement), the UE may transmit a PDU session establishment or modification request message and include the connection capability of the URSP rule to which the application is matched in the message.

The traffic descriptor may be configured through one or more of a connection capability (e.g., a specific application category, or an operator-defined application category, and the like) and an application descriptor (e.g., operating system application ID (OSAppID)).

The route selection descriptor may be configured as S-NSSAI selection, DNN selection, or the like, and the S-NSSAI selection and the DNN selection may include S-NSSAI(s) and DNN(s), respectively.

In step 201, if a request for PDU session information for application traffic transmission occurs in the upper layer or if new application traffic is detected, the UE may find a URSP rule matching the URSP rule received in step 200 and transmit a PDU session establishment request message, based on this. If one or more application traffics are detected, the UE may transmit a PDU session establishment request message for one or more PDU sessions, so that one or more PDU sessions may be established.

When the UE is located in an evolved packet system (EPS) (i.e., when the UE is receiving a service through the EPS), when the association information between the PDN connection/PDU session and the application/PIN is generated by the matching URSP rule, if the matching URSP rule includes an indication for further reporting URSP rule enforcement (or an indication for reporting URSP rule enforcement), the UE may store the matching URSP rule or the connection capability (or OS identifier, application identifier, OSApp identifier, etc.) included in the matching URSP rule.

In step 202 the UE may perform URSP rule re-evaluation. That is, the UE may re-perform the process of finding a URSP rule matching the existing application (or ongoing application). The UE may perform URSP rule re-evaluation in the following cases:
When the UE performs periodic URSP rule re-evaluation, based on the UE implementation
When the UE non-access stratum (NAS) layer releases an existing PDU session (i.e., the PDU session associated to the application) used for traffic routing of a PIN (personal IoT network) or application based on URSP rules
When the URSP rules are updated by the PCF
When the UE NAS layer indicates that the UE is performing an inter-system change from S1 mode to N1 mode
When the UE NAS layer indicates that the UE is successfully registered in N1 mode through 3GPP access or non-3GPP access
When the UE establishes or releases a connection to wireless local area network (WLAN) access and when PDU transmission (i.e., traffic transmission) of the application is enabled or disabled through non-3GPP access outside the PDU session
When an allowed NSSAI, a partially allowed NSSAI, or a configured NSSAI is changed
When local-area data network (LADN) information or extended LADN information is changed
When the UE NAS layer indicates that a NAS backoff timer has stopped or expired
When the UE NAS layer indicates a successful change of a public land mobile network (PLMN)
When the UE NAS layer indicates that the current tracking area identity (TAI) is in the list of tracking areas (TAs) where the S-NSSAI is allowed

If the PDU session associated to the existing application according to the matching URSP rule is changed to one of the previously established PDU sessions in step 202, the UE may perform step 203.

In step 203, if the PDU session associated to the existing application according to the matching URSP rule is changed to one of the previously established PDU sessions, and if the matching URSP rule includes an indication for further reporting URSP rule enforcement (or an indication for reporting URSP rule enforcement), the UE may transmit a PDU session modification request message to the AMF. The PDU session modification request message may include a connection capability (or an OS identifier, an application identifier, an OSApp identifier, etc.) included in the matching URSP rule together with a PDU session ID newly associated with the application. The PDU session modification request may be transmitted to the AMF through the RAN.

When the UE moves from the EPS to the 5GS, if there is association information between the PDN connection/PDU session and the application in the evolved packet core (EPC), the UE may transmit a PDU session modification request message to the AMF, such as when there is URSP rule information or a connection capability (or an OS identifier, an application identifier, an OSApp identifier, etc.) stored for the stored association information (i.e., association information between the PDN connection/PDU session and the application). When the UE moves from the EPS to the 5GS through interworking with an N26 interface between the MME and the AMF, the UE may perform URSP rule enforcement reporting through the PDU session modification request message.

The PDU session modification request message may include a connection capability (or an OS identifier, an application identifier, an OSApp identifier, etc.) included in the matching URSP rule together with the PDU Session ID. The PDU session modification request may be transmitted to the AMF through the RAN. The UE may perform URSP rule enforcement reporting through the PDU session modification request message when moving from the EPS to the 5GS through interworking without the N26 interface.

In step 204, if the AMF receives a PDU session establishment request message from the UE, the AMF may transmit an SM context update message to the SMF. One or more of a connection capability, an OS identifier, an App identifier, and an OSApp identifier included in the PDU session establishment request message received from the UE may be included in the SM context update message.

In step 205, the SMF may transmit path information (e.g., S-NSSAI and DNN) together with the connection capability (or the OS identifier, the App identifier, the OSApp identifier, etc.) received from the AMF to the SM-PCF.

In step 206, the SM-PCF may forward the path information (e.g., S-NSSAI and DNN) and a PDU session ID together with the connection capability (or the OS identifier, the App identifier, the OSApp identifier, etc.) received from the SMF to the UE PCF.

Referring back to step 204, the AMF may also directly transmit the connection capability (or OS identifier, App identifier, or OSApp identifier) together with the path information to the UE PCF.

Referring back to step 206, if the UE PCF receives one or more of the connection capability, the OS identifier, the App identifier, and the OSApp identifier along with the path information (e.g., S-NSSAI, DNN, etc. for the PDU session), the UE-PCF may determine whether the current path is determined according to the URSP rule for the UE or whether the current path is suitable (e.g., whether the application category included in the connection capability is using suitable S-NSSAI and DNN). If the current path is not determined according to the URSP rule for the UE or if the current path is determined to be unsuitable, the UE PCF may update the URSP rule and transmit the updated URSP rule to the UE.

If it is determined that there is no existing established PDU session satisfying the matching URSP rule for the existing application in step 202, and if the matching URSP rule includes an indication for further reporting URSP rule enforcement (or an indication for reporting URSP rule enforcement), the UE may transmit a PDU session establishment request message to the AMF in step 207. The PDU session establishment request message may include a PDU session ID newly associated to the application, the S-NSSAI and DNN included in the URSP rule, and the connection capability (or the OS identifier, the App identifier, the OSApp identifier, etc.) included in the URSP rule. The PDU session establishment request may be transmitted to the AMF through the RAN.

When the UE moves from the EPS to the 5GS, if there is association information between the PDN connection/PDU session and the application in the EPC, the UE may transmit a PDU session establishment request message to the AMF, such as when there is URSP rule information or a connection capability (or an OS identifier, an application identifier, an OSApp identifier, etc.) stored for the stored association information (i.e., association information between the PDN connection/PDU session and the application).

The PDU session establishment request message may include a connection capability (or an OS identifier, an application identifier, an OSApp identifier, etc.) for the matching URSP rule along with a PDU session ID. The information may be information stored in the EPS. The PDU session establishment request may be transmitted to the AMF through the RAN. If the UE moves from the EPS to the 5GS without using an N26 interface (i.e., moves from the EPS to the 5GS through interworking without N26), he UE may perform URSP rule enforcement reporting through the PDU session establishment request message.

In step 208, if the AMF receives the PDU session establishment request message from the UE, the AMF may transmit an SM context create message to the SMF. One or more of a connection capability, an OS identifier, an App identifier, and an OSApp identifier included in the PDU session establishment request message received from the UE may be included in the SM context create message.

In step 209, the SMF may transmit path information (e.g., S-NSSAI and DNN) together with the connection capability (or OS identifier, App identifier, or OSApp identifier) received from the AMF to the SM-PCF.

In step 210, the SM-PCF may forward the path information (e.g., S-NSSAI and DNN) and the PDU session ID, along with the connection capability (or OS identifier, App identifier, or OSApp identifier) received from SMF, to the UE PCF.

Referring back to step 208, the AMF may also directly transmit the connection capability (or OS identifier, App identifier, or OSApp identifier) to the UE PCF along with the path information.

If the UE PCF receives one or more of the connection capability, the OS identifier, the App identifier, and the OSApp identifier along with the path information (e.g., S-NSSAI and DNN for the PDU session, etc.), the UE may determine whether the current path is determined according to the URSP rule for the UE or whether the current path is suitable (e.g., whether the application category included in the connection capability is using suitable S-NSSAI and DNN). If the current path is not determined according to the URSP rule for the UE or if the current path is determined to be unsuitable, the UE PCF may update the URSP rule and transmit the updated URSP rule to the UE, or transmit a message for changing the S-NSSAI and DNN of the PDU session to the SM PCF. The message may include an SM policy association ID or a PDU session ID, an alternative S-NSSAI, and an alternative DNN. If only the S-NSSAI needs to be changed, only the alternative S-NSSAI may be included. If only the DNN needs to be changed, only the alternative S-NSSAI may be included.

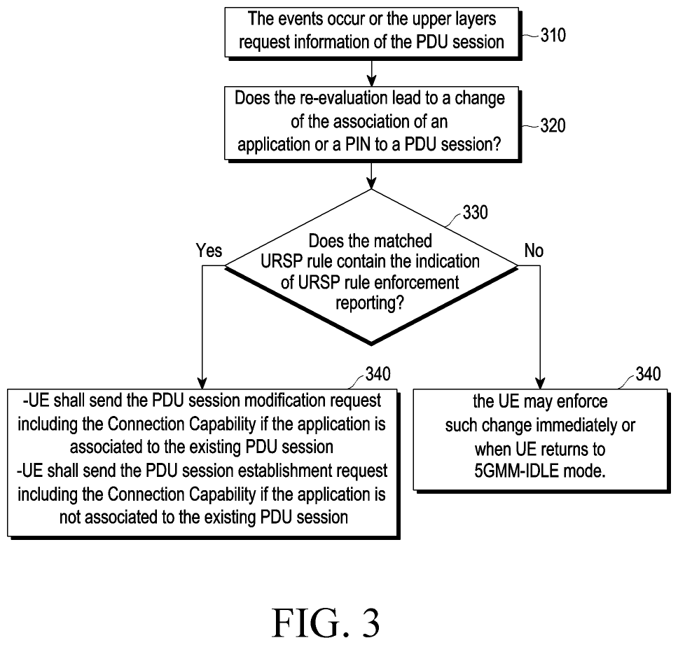

FIG. 3 illustrates an operation in which a UE reports a matching URSP rule when performing URSP rule re-evaluation according to an embodiment. FIG. 3 pertains to when the URSP rule re-evaluation included in step 202 of FIG. 2 is performed.

Referring to FIG. 3, in step 310, the UE may identify the occurrence of events for the URSP rule re-evaluation or receive a request for PDU session information from upper layers.

In step 320, the UE may determine whether the URSP rule re-evaluation requires an association change of an application or a PIN change for a PDU session.

In step 330, the UE may identify whether the matching URSP rule includes URSP rule enforcement reporting.

If the matching URSP rule includes URSP rule enforcement reporting, the UE may transmit a PDU session modification request or a PDU session establishment request message in step 340. If the application is associated with a currently existing PDU session, the UE may transmit a PDU session modification request, and the PDU session modification request may include a connection capability. If the application is not associated with a currently existing PDU session, the UE may transmit a PDU session establishment request including a connection capability.

If the matching URSP rule does not include URSP rule enforcement reporting, the UE may perform PDU session modification or the like immediately or upon returning to 5G mobile management idle (5GMM-IDLE) mode in step 350.

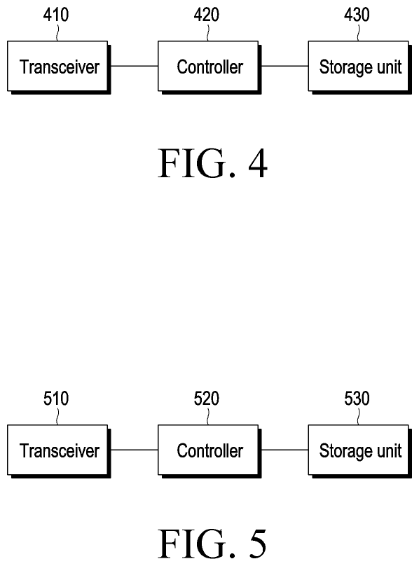

FIG. 4 illustrates a UE according to an embodiment.

Referring to FIG. 4, the UE may include a transceiver 410, a controller 420, and a storage unit 430.

The transceiver 410 may transmit and receive signals to and from a base station or a network entity. The transceiver 410 may transmit and receive data to and from a base station or a network entity using, for example, wireless communication.

The controller 420 may control the overall operation of the UE. For example, the controller 420 may control signal flow among the respective blocks to perform the operation described with reference to FIGS. 1 to 3. The controller 520 may be defined as a circuit, an application-specific integrated circuit, or at least one processor.

The storage unit 430 may store at least one piece of information transmitted and received through the transceiver 410 and information generated through the controller 420. For example, the storage unit 430 may store information and data necessary for the method described with reference to FIGS. 1 to 3.

FIG. 5 illustrates a network entity according to an embodiment.

The network entity in FIG. 5 may be implemented as one of the base station RAN, AMF, SMF, SM PCF, and UE PCF illustrated in FIGS. 1 to 3. Referring to FIG. 5, the network entity may include a transceiver 510, a controller 520, and a storage unit 530.

The transceiver 510 may transmit and receive signals to and from the UE, the base station, or another network entity. The transceiver 510 may transmit and receive data to and from the UE, the base station, or another network entity using, for example, wireless communication.

The controller 520 may control the overall operation of the network entity. For example, the controller 520 may control the signal flow between the respective blocks to perform the operation described with reference to FIGS. 1 to 3. The controller 520 may be defined as a circuit, an application-specific integrated circuit, or at least one processor.

The storage unit 530 may store at least one of information transmitted and received through the transceiver 510 and information generated through the controller 520. For example, the storage unit 530 may store information and data necessary for the method described with reference to FIGS. 1 to 3.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method of a user equipment (UE) in a wireless communication system, the method comprising:
determining whether the UE changes an association of an application to a packet data unit (PDU) session based on a UE routing selection policy (URSP) re-evaluation;
reporting information about a URSP rule matched to the application to a session management function (SMF) using a PDU session modification request message based on the UE associating the application to an existing PDU session based on the URSP re-evaluation; and
reporting information about the URSP rule matched to the application to the SMF using a PDU session establishment request message based on the UE associating the application to a new PDU session based on the URSP re-evaluation.

2. The method of claim 1, further comprising:
detecting that an event related to the URSP re-evaluation occurs.

3. The method of claim 1,
wherein the PDU session modification request message comprises at least one of connection capability, an operating system (OS) identifier (ID), an application ID, or an OS application ID (OSAppID).

4. The method of claim 1,
wherein the PDU session establishment request message comprises at least one of connection capability, an operating system (OS) identifier (ID), an application ID, or an OS application ID (OSAppID).

5. The method of claim 1, further comprising:
determining whether an indicator for reporting an enforcement of URSP rules is included in the URSP rules; and
transmitting the PDU session modification request message to the AMF, based on the indicator being included in the URSP rules.

6. A user equipment (UE) in a wireless communication system, the UE comprising:
a transceiver; and
a controller,
wherein the controller is configured to:
determine whether the UE changes an association of an application to a packet data unit (PDU) session based on a UE routing selection policy (URSP) re-evaluation;
report information about a URSP rule matched to the application to a session management function (SMF) using a PDU session modification request message based on the UE associating the application to an existing PDU session based on the URSP re-evaluation; and
report information about the URSP rule matched to the application to the SMF using a PDU session establishment request message based on the UE associating the application to a new PDU session based on the URSP re-evaluation.

7. The UE of claim 6, wherein the controller is further configured to:
detect that an event related to the URSP re-evaluation occurs.

8. The UE of claim 6,
wherein the PDU session modification request message comprises at least one of connection capability, an operating system (OS) identifier (ID), an application ID, or an OS application ID (OSAppID).

9. The UE of claim 6,
wherein the PDU session establishment request message comprises at least one of connection capability, an operating system (OS) identifier (ID), an application ID, or an OS application ID (OSAppID).

10. The UE of claim 6, wherein the controller is further configured to:
determine whether an indicator for reporting an enforcement of URSP rules is included in the URSP rules; and
transmit the PDU session modification request message to the AMF, based on the indicator being included in the URSP rules.
